(19) United States
(12) Patent Application Publication
(10) Pub. No.: US 2009/0199299 A1
(43) Pub. Date: Aug. 6, 2009

(54) INTEGRATED USER EXPERIENCE WHILE ALLOCATING LICENSES WITHIN VOLUME LICENSING SYSTEMS

(75) Inventors: Casey Alexander John McKinnon, Seattle, WA (US); Damien Gallot, Bellevue, WA (US); Michael Kostersitz, Monroe, WA (US); Thomas William Keane, Seattle, WA (US); Ashish Sikka, Redmond, WA (US); Marc Andrew Walker, Mill Creek, WA (US); Anandhi Somasekaran, Redmond, WA (US); Sarang Tekmalkar, Redmond, WA (US); Tolga Acar, Sammamish, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/024,099

(22) Filed: Jan. 31, 2008

(51) Int. Cl. G06F 21/00

(52) U.S. Cl. 726/26

(57) ABSTRACT

This description provides tools for providing integrated user experiences while allocating licenses within volume licensing systems. These tools may provide methods that include sending information for presenting licensing portals at recipient organizations. The licensing portals may include representations of properties licensed by the organizations, and may include indications of how many licenses remain available for allocation. The methods may include receiving and validating licensing requests. The tools may provide other methods that include requesting and receiving information for presenting the licensing portals, as well as requesting and receiving licensing-related actions from the licensing systems. The tools may provide still other methods that include receiving requests for information to present launch portals, with these requests incorporating user identifiers for particular end-users. These methods may also populate the launch portals with representations of properties for which the end-users are licensed, and may send the information for the launch portals to licensee organizations.

### BACKGROUND

Within some corporate enterprises, administrators or other users may typically acquire software (whether delivered on CD or other media, or downloaded), and then physically install the software on various machines within the enterprise. In this environment, tracking how many licenses a given enterprise may have acquired may become difficult. It may also become challenging to identify to whom enterprise personnel have allocated licenses, to determine how many licenses are made available for allocation, and whether the enterprise as a whole is currently complying with applicable licenses. In some cases, once software is installed on a given machine, an end-user accessing that machine may also access the software, whether or not the enterprise is complying with any applicable license for the software.

### SUMMARY

This description provides tools for providing integrated user experiences while allocating licenses within volume licensing systems. These tools may provide methods that include sending information for presenting licensing portals at recipient organizations. The licensing portals may include representations of properties licensed by the organizations, and may include indications of how many licenses remain available for allocation. The methods may include receiving and validating licensing requests. The tools may provide other methods that include requesting and receiving information for presenting the licensing portals, as well as requesting and receiving licensing-related actions from the licensing systems. The tools may provide still other methods that include receiving requests for information to present launch portals, with these requests incorporating user identifiers for particular end-users. These methods may also populate the launch portals with representations of properties for which the end-users are licensed, and may send the information for the launch portals to licensee organizations.

The above-described subject matter may also be implemented as a method, computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a combined block a flow diagram illustrating systems or operating environments that enable integrated user experiences while allocating licenses within volume licensing systems.

FIG. 2 is a flowchart illustrating processes for allocating and managing licenses between licensor and licensee organizations.

FIG. 3 is a flowchart illustrating processes that provide additional detail on certain processing illustrated in FIG. 2.

FIG. 4 is a database diagram illustrating records and structures suitable for constructing one or more licensing databases as described herein.

FIG. 5 is a user interface (UI) diagram, illustrating a UI for assigning or allocating licenses or services to a particular end-user.

FIG. 6 is a UI diagram, illustrating elements for editing user configurations.

FIG. 7 is a UI diagram, illustrating elements for indicating how many licenses for different example properties remain available for allocation across a given licensee organization.

FIG. 8 is a flowchart illustrating processes for requesting and populating a launch portal or launch UI presented to an end-user on a workstation.

FIG. 9 is a UI diagram, illustrating elements that a workstation may present to enable the end-user to launch or access one or more properties licensed to the end-user.

### DETAILED DESCRIPTION

The following detailed description is directed to technologies for integrated user experiences while allocating licenses within volume licensing systems. While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

In the following detailed description, references are made to the accompanying drawings that form a part hereof, and which are shown by way of illustration specific embodiments or examples. Referring now to the drawings, in which like numerals represent like elements through the several figures, aspects of tools and techniques for integrated user experiences while allocating licenses within volume licensing systems will be described.

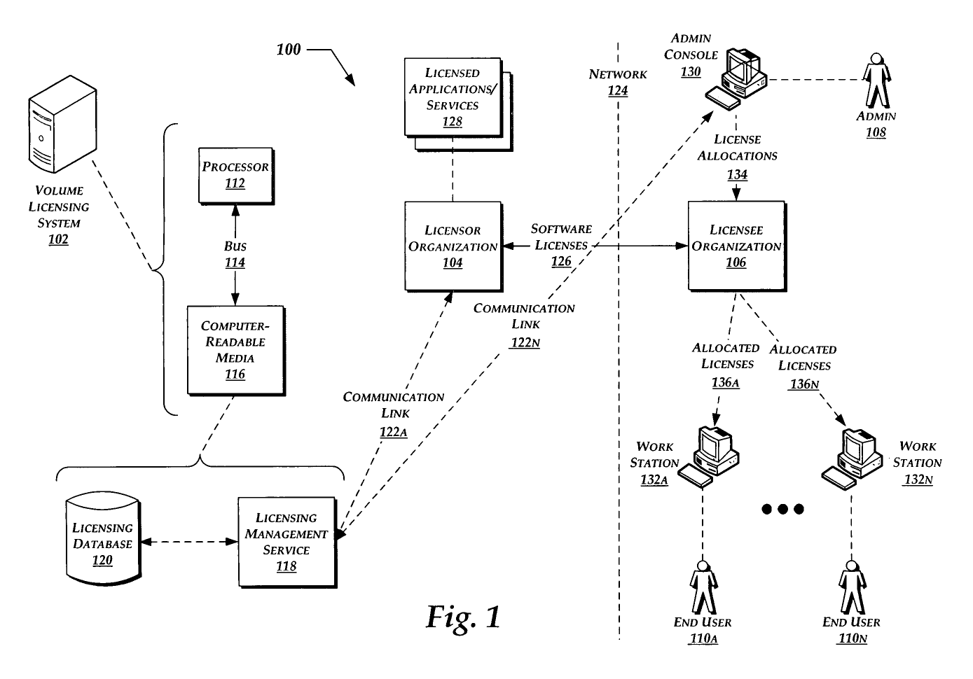

FIG. 1 illustrates systems or operating environments, denoted generally at 100, that enable integrated user experiences while allocating licenses within volume licensing systems. These systems 100 may include one or more volume licensing server systems 102. However, implementations of the description herein may include any number of servers 102. As described in further detail below, the server systems 102 may cooperate with one or more licensor organizations 104 and one or more licensee organizations 106 to provide an integrated license management experience for administrative personnel 108 and end users 110a and 110n (collectively, end users 110).

The graphical elements used in FIG. 1 to depict the server systems, and other processor-based systems shown throughout the drawings, are chosen only to facilitate illustration, and not to limit possible implementations of the description herein. However, the description herein also contemplates other forms of server systems, including but not limited to, those shown in FIG. 1.

Turning to the servers 102 in more detail, the servers may include one or more processors 112, which may have a particular type or architecture, chosen as appropriate for particular implementations. The processors 112 may couple to one or more bus systems 114 chosen for compatibility with the processors 112.

The servers 102 may also include one or more instances of computer-readable storage media 116, which couple to the bus systems 114. The bus systems may enable the processors 112 to read code and/or data to/from the computer-readable storage media 116. The media 116 may represent storage elements implemented using any suitable technology, including but not limited to semiconductors, magnetic materials, optics, or the like. The media 116 may include memory components, whether classified as RAM, ROM, flash, or other types, and may also represent hard disk drives.

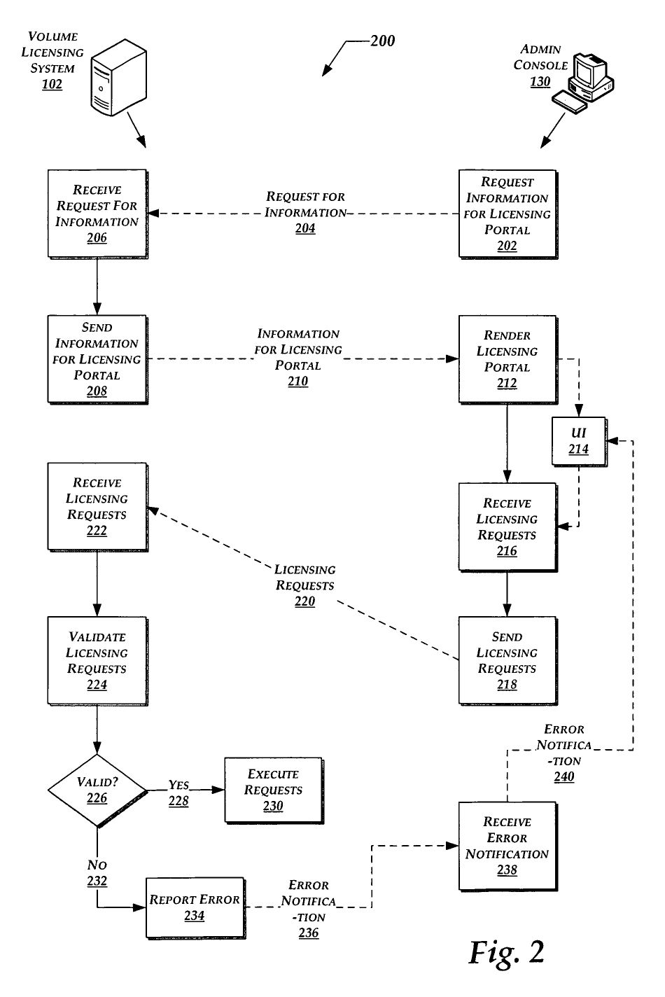

The storage media 116 may include one or more modules of instructions that, when loaded into the processor 112 and executed, cause the server 102 to perform various techniques for integrated user experiences while allocating licenses within volume licensing systems. In the example shown in FIG. 2, the computer readable media 116 may include software modules, denoted generally at 118, for providing a licensing management service. In addition, the media 116 may also include a licensing database 120 that cooperates with the licensing management service 118. FIG. 1 represents this cooperation by the dashed line connecting blocks 118 and 120. The discussion below provides further details relating to processing performed by the licensing management service 118, as well as data structures for the licensing database 120. As detailed throughout this description, these servers 102 may provide volume license management services using the components, flows, and data structures now described in connection with FIG. 1.

The licensing management service 118 may communicate via respective communication links 122a and 122n (collectively, communication links 122). FIG. 1 shows an example including two communication links, but implementations of this description may include any number of communication links, depending upon the number of licensor and licensee organizations supported.

As shown in FIG. 1, the licensing management service 118 may communicate over one or more networks 124 with the licensor organization 104. In the example shown, the communication link 122n passes over the network 124, with the licensor organization 104 and the licensee organization 106 managing one or more software licenses 126 over the network. In other examples, the licensing management service 118 may communicate with the licensor organization 104 over networks as well. Generally, the network 124 may represent any suitable local area, regional, or global communications network (e.g., the Internet). The communication links 122 as shown in FIG. 1 may represent any adapters, interfaces, and any hardware and/or software appropriate for communicating over such networks, however configured.

Turning to the licensor organization 104 in more detail, this organization may license one or more applications or services 128 to a variety of different licensee organizations 106. The licensor and licensee organizations may establish one or more software licenses 126 under which the licensor provides the applications and/or services 128 to the licensees. The arrow 126 in FIG. 1 generally represents rights to access such applications or services, as well as corresponding payments.

It is noted that the systems 100 described herein may support any number of licensor organizations and licensee organizations, with the example provided in FIG. 1 shown only for clarity of illustration. In addition, the licensor organization 104 may itself operate the volume licensing system 102. However, in other instances, a third party may operate the volume licensing system 102 on behalf of a plurality of licensor and/or licensee organizations.

Turning to the licensee organization in more detail, this organization may operate one or more administrative consoles, shown collectively at 130. As described in further detail below, the licensee organization 106 may obtain any number of licenses as appropriate to operate a variety of processor-based machines. The admin consoles 130 may communicate with the licensing management service 118 over the communication link 122n. In this manner, the consoles 130 may enable the licensing management service 118 to communicate with the licensee organization 106. Administrative personnel 108 may use the admin consoles 130 to allocate these licenses to a variety of end users 110 and/or corresponding workstations 132a and 132n (collectively, workstations 132). FIG. 1 represents these license allocations from the admin consoles at 134, and represents the licenses as allocated to the various workstations at 136a and 136n (collectively, allocated licenses 136).

Having described the overall systems and operating environments 100 for integrated user experiences while allocating licenses within volume licensing systems, the discussion now proceeds to a description of process flows for allocating and managing the licenses. This description is now presented with FIG. 2.

FIG. 2 illustrates process flows, denoted generally at 200, for allocating and managing licenses between licensor and licensee organizations. For ease of reference, and not limitation, FIG. 2 may carry forward some reference numbers from previous drawings to refer to similar items. For example, FIG. 2 carries forward from FIG. 1 examples of a volume licensing system at 102 and the admin console 130. In the example shown, the volume licensing system cooperates with the admin console, with processing shown by each item arranged in columns for convenience of discussion only.

Turning to the admin console, block 202 generally represents software running on the console requesting information for a licensing portal from the volume licensing system. More specifically, block 202 may include requesting information used to populate, provide, and/or present the licensing portal on the admin console. In the example shown, the admin console and the volume licensing system may interact within a web-based rouser system, with the licensing portal being presented on the admin console to enable personnel associated with the licensee organization to interact with the licensor organization through the volume licensing system. FIG. 2 denotes the request for the licensing portal information at 204.

Block 206 generally represents receiving the request 204 for the licensing portal information, and block 208 generally represents sending the information for the licensing portal to the admin console in response to this request. Block 208 may include creating and sending appropriate HTML code that, when rendered on the admin console, presents a licensing portal 210 to administrative personnel using the admin console.

Block 212 generally represents rendering the licensing portal on the admin console. More specifically, block 212 may arrange certain aspects of the licensing portal on the admin console via one or more user interfaces (UI), denoted generally at 214. Subsequent drawing figures provide various non-limiting examples of such UIs 214.

The admin personnel may interact with such UIs to request that the admin console and/or the volume licensing system perform various processing associated with managing and allocating licenses obtained by the licensee organization. Generally, block 216 represents receiving requests related to various licensing functions, and block 218 represents sending these licensing requests 220 to the volume licensing system.

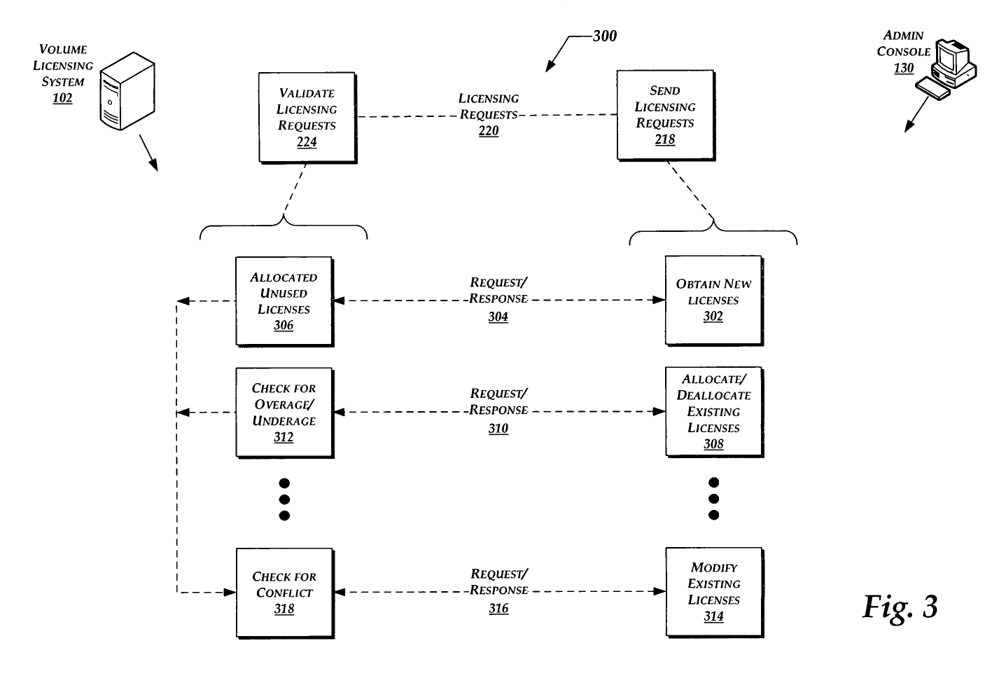

At the volume licensing system, block 222 generally represents receiving various licensing requests 220, and block 224 generally represents validating these licensing requests. FIG. 3 elaborates further on various examples of these licensing requests and related validations, but in overview, block 224 performs a validity check on the requested actions.

Decision block 226 generally represents testing whether the requested action is valid. If the action requested by the licensee organization is valid and permissible, the processes 200 may take Yes branch 228 to block 230, which generally represents executing or performing the requested action. On the other hand, returning to decision block 226, if the requested action is invalid or otherwise impermissible, then the process flows 200 may take No branch 232 to block 234, which represents reporting an error condition. Block 234 may include sending an error notification 236 to the admin console.

At the admin console, block 238 represents receiving the error notification 236. Block 238 may include forwarding the error notification (denoted at 240) to the admin console, for presentation on the UI 214.

It is noted that various software components may perform the various processing shown in FIG. 2. For example, the licensing management service 118 may perform the processing shown on the left side of FIG. 2 on behalf of the volume licensing system, and may also push software to the admin console that performs the processing represented on the right side of FIG. 2.

Having described the processes 200 as shown in FIG. 2, the discussion now proceeds to a more detailed description of various examples of licensing requests and related validation. This description is now provided with FIG. 3.

FIG. 3 illustrates process flows, denoted generally at 300, that provide additional detail on certain processing illustrated above in FIG. 2. For ease of reference, and not limitation, FIG. 3 may carry forward some reference numbers from previous drawings to refer to similar items. For example, FIG. 3 carries forward the volume licensing system 102 and the admin console 130. In addition, FIG. 3 carries forward blocks 218 and 224 from FIG. 2. Block 218 represents sending licensing requests 220 from the admin console to the volume licensing system, while block 224 represents validating these licensing requests.

Turning to the examples of licensing requests that may be sent in block 218, licensee organizations may request to obtain new licenses, as denoted generally at 302. Block 302 may include sending this request for new licenses, as noted by the dashed line 304, and new licenses may be obtained by purchase, lease, or any other suitable financial transaction.

At the volume licensing system, block 224 may include responding to the request for new licenses by first checking whether the licensee organization has any remaining unallocated or unused licenses, as denoted generally at block 306. If so, block 306 may include allocating these unused licenses and communicating the same back to the admin console 130, as also represented by the dashed line 304. However, if the licensee organization does not have any remaining unallocated licenses, block 306 may include accepting the request to purchase new licenses, and updating records associated with the licensee organization accordingly.

Returning to the admin console, block 308 represents requesting to allocate or deallocate existing licenses as were previously assigned to particular end users (e.g., 110) and/or workstations (e.g., 132). FIG. 3 denotes such requests at 310, as sent to the volume licensing system.

At the volume licensing system, block 312 may include checking the request 310 to see whether granting a request to allocate additional licenses (or, “seats”) would result in an overage situation, in which the number of licenses allocated to the licensee organization exceeds the maximum number of licenses paid for or permitted under the applicable license. The volume licensing system may associate an overage percentage with the assignment of the license package. The system may enforce licenses based on the number of seats allocated and the percentage of overage allowed. Additional seats may be requested and administered via the volume licensing system. If the request to allocate additional licenses would result in overage, block 312 may include granting this request and noting the overage for billing and administrative purposes. In these cases, the licensor may bill a licensee at some predefined rate for such overage.

In other cases, if the request to allocate additional licenses would result in overage (i.e., the number of seats available and allocated, plus the percentage of allowed overage), block 312 may deny this request. In such cases, block 312 may include notifying the admin console that granting the request would exceed the maximum number of licenses permitted under the applicable agreement. In such circumstances, block 312 may also offer the admin console corrections on how to purchase additional licenses (e.g., as represented in block 302). In FIG. 3, the dashed arrow 310 also represents these various possible responses from the volume licensing system.

In some instances, block 308 may include requests to deallocate existing licenses. In such cases, block 312 may include checking whether such requests may result in an underage situation, in which a number of allocate licenses falls beneath a minimum level specified in the applicable license agreement. If so, block 312 may include so notifying the admin console.

Returning to the admin console, block 314 generally represents requests to modify settings or configurations related to existing license allocations. For example, admin personnel may adjust various parameters associated with licenses allocated to particular end users and/or workstations. FIG. 3 denotes these requests to modify by the dashed line 316.

At the volume licensing system, block 318 generally represents checking for any conflicts that may result from granting the modification request 316. For example, block 318 may include checking that any changes to parameters requested in block 314 do not exceed permissible ranges as established in the applicable licensing agreement.

In general, the volume licensing system may perform block 318 to check for any conflicts that may result in connection with blocks 306 and 312. FIG. 3 illustrates this processing by the arrows connecting blocks 306 and 312 to block 318.

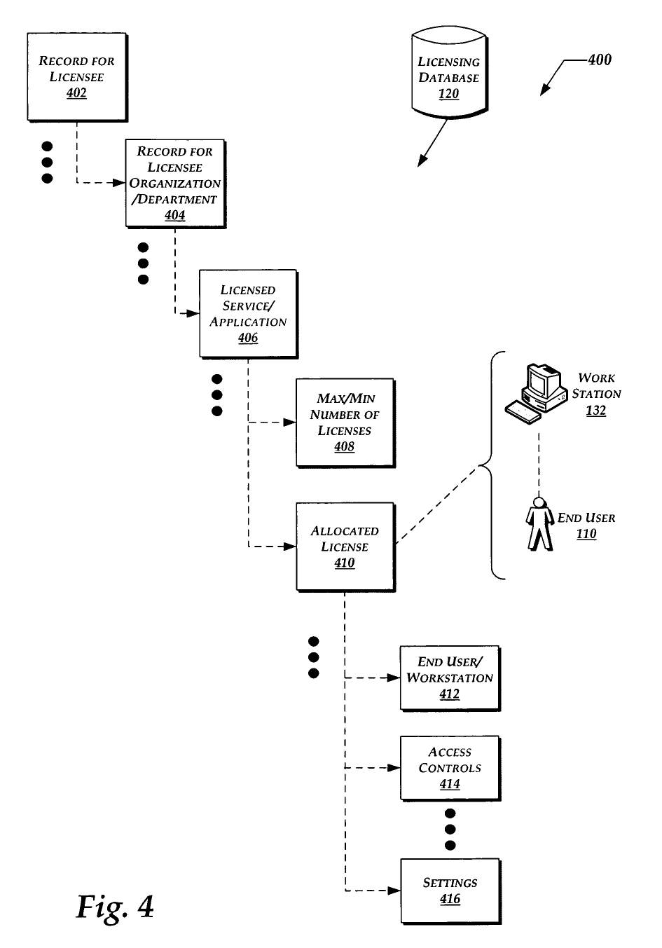

Having described the additional examples of the process flows 300 in FIG. 3, the discussion now turns to a more detailed description of records and structures suitable for the licensing database. This description is now provided with FIG. 4.

FIG. 4 illustrates records and structures, denoted generally at 400, suitable for constructing one or more licensing databases as described herein. For ease of reference, and not limitation, FIG. 4 may carry forward some reference numbers from previous drawings to refer to similar items. For example, FIG. 4 carries forward the licensing database 120 from FIG. 1, as well as the workstation 132 and associated end-user 110.

Turning to the licensing database 120 in more detail, it may define one or more master records 402, under which sub-records for particular licensee organizations are organized. For example, a given licensee organization may be organized into one or more sub-organizations or departments for licensing purposes. In such scenarios, the licensing database 120 may include corresponding sub-records 404 associated with these different organizations or departments. Assuming a corporate enterprise implementation, for example, a master record 402 may correspond to a licensee company as a whole, with sub-records 404 corresponding to different departments within the company (e.g., executive, sales, legal, marketing, or the like).

In some scenarios, particular organizations or departments within an enterprise may have licensed services and/or applications from a licensor organization. Records 406 may indicate particular services and/or applications that the licensee organization as licensed. In the example shown, these licenses are associated with particular department records 404. However, in instances where the enterprise as a whole license some service or application, the license records 406 may be associated directly with the master licensee record 402.

Turning to the licensed application records 406 in more detail, sub-records 408 associated with this record may indicate maximums and/or minimums of permitted license allocations under the applicable agreement. The maximum and/or minimum parameters may enable the volume licensing system, operating in connection with the licensing database, to identify overage and/or underage scenarios, as discussed above in FIG. 3 with block 312.

The licensed application records 406 may also include allocation records 410 corresponding to particular allocations of licenses or seats under a given licensing agreement. For example, the allocation records 410 may indicate particular end users (e.g., 110) and/or particular workstations (e.g., 132) to which the licensee organization has allocated licenses.

Turning to the allocated license sub-records 410 in more detail, these records may include various sub-records that contain particulars relating to specific allocations. For example, an end-user/workstation record 412 may identify a particular end-user and/or workstation to which a license is allocated.

Access control sub-records 414 may identify any controls or restrictions applicable to a given allocate a license. For example, different users may receive different levels of access within a given service or application, may access such services or applications with different levels of privilege, or the like.

Settings sub-records 416 may indicate particular parameters or configuration settings established when allocating a particular license to a particular end-user and/or workstation. For example, administrative personnel and/or automated processes may define these printers or settings when initially allocating licenses to particular end users and/or workstations, but may also modify these parameters and settings afterwards.

The licensing database 140, and related structures illustrated in FIG. 4, may facilitate various processing performed by or on behalf of the volume licensing system. For example, block 312 shown in FIG. 3 may identify overage and/or underage scenarios by comparing maximums and/or minimums (e.g., record 408) to the total number of allocated licenses (e.g., aggregating records 410). The licensing database 120 may also provide an integrated view of all licenses obtained by a given enterprise, or sub-organization thereof, and may also provide reporting capabilities that indicate how these licenses are allocated within the enterprise or organization. The licensing database may also enable processes associated with the volume licensing system to aggregate users and/or workstations across a given enterprise, or sub-organization thereof, to which licenses have been allocated.

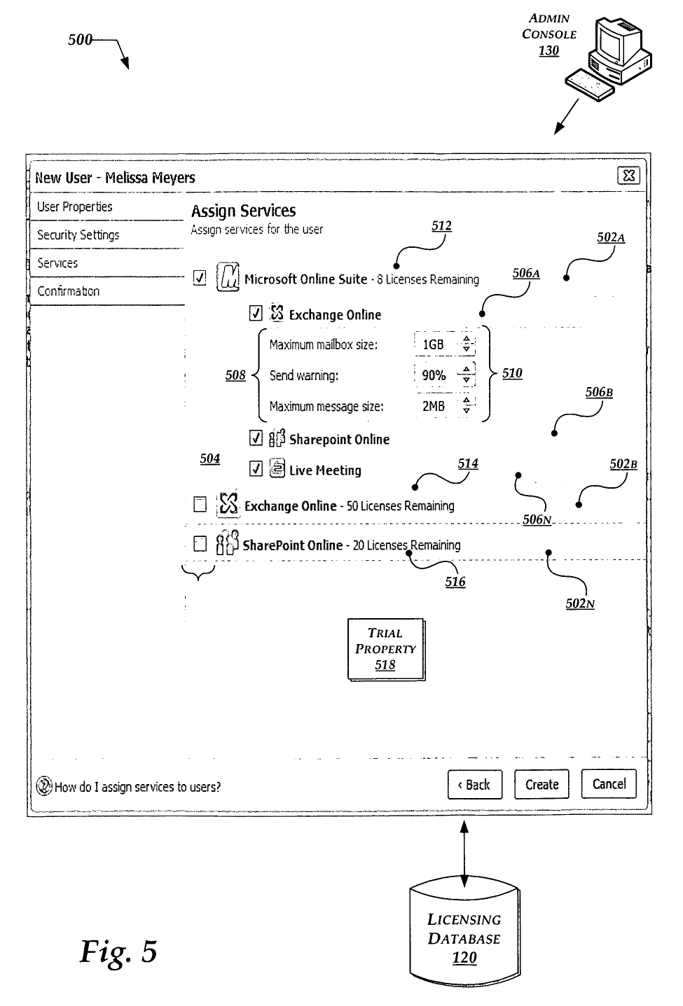

Having described the example records and structures of the licensing database 120, the discussion now turns to descriptions of various UI elements that may facilitate operation of the volume licensing systems described herein. These descriptions are now provided with FIGS. 5-7.

FIGS. 5-7 provide various examples of UI elements that may be displayed on admin consoles (e.g., 130) in connection with operating the volume licensing systems described herein. In different scenarios, these UI elements may support interaction with admin personnel (e.g., 108) to perform various processes associated with the volume licensing systems, as now described in more detail in the following examples. Referring specifically to the UIs shown in FIGS. 5-7, these UIs provide examples of licensing portals through which the admin consoles may administer various aspects of the volume licensing systems described herein.

Turning first to FIG. 5, this figure illustrates an example UI, denoted generally at 500, for assigning or allocating licenses or services to a particular end-user. More specifically, the UI 500 shown in FIG. 5 may be used to allocate licenses to a new end-user.

In the example shown in FIG. 5, the UI 500 includes representations of three different services and/or applications that may be allocated to the particular end-user. FIG. 5 denotes these examples at 502a, 502b, and 502n (collectively, licensed applications 502). It is noted that FIG. 5 provides various examples of services available from Microsoft Corporation of Redmond, Wash. However, these examples are provided for ease of description only, and not to limit possible implementations. The tools and techniques described herein may readily be implemented with software and services provided by any number of other vendors.

The UI 500 may include instances of checkboxes or other similar tools responsive to user input to either allocate or deallocate the various licensed applications to the given end-user. FIG. 5 denotes these tools generally at 504, illustrating an example in which the service entitled “Microsoft Online Suite” is activated for allocation to the new user. In this particular example, the activated service includes various subcomponents, denoted respectively at 506a, 506b, and 506n (collectively, subcomponents 506). The UI 500 may also include checkboxes or other tools for selecting or deselecting these various subcomponents, as indicated collectively at 508 in FIG. 5. In the example shown, all three of these subcomponents have been selected for allocation to the new end-user.

Turning to the subcomponent 506a—entitled “Exchange Online”—in more detail, FIG. 5 illustrates examples of UI elements 510 that allow configuration of various settings relating to a license allocated to the particular end-user. In the example shown, these UI elements 510 provide various tools via which admin personnel may configure the Exchange Online service for the particular end-user. For example, the admin may establish a maximum mailbox size, may specify what percentage of the mailbox is filled before the end user receives a warning, may establish a maximum message size, or the like.

The UI 500 may also indicate how many licenses remain available for allocation, for any properties (e.g., applications, services, or the like) depicted in the UI. In the example shown, the licensed application 502a has eight licenses remaining, as indicated at 512. Similarly, the application 502b has fifty licenses remaining, as indicated at 514, and the application 502n as twenty licenses remaining, as indicated at 516.

Over time, as operations proceed and licenses to various properties are allocated and/or deallocated to/from various end-users, the UI 500 may appropriately update entries in the licensing database (e.g., 120) for these various properties. In turn, the UI 500 may update the areas (e.g., 512, 514, and 516) that indicate how many licenses to these properties are available for allocation to be end-users.

In some implementations, the UI 500 may include representations of properties offered under trial licenses. For example, a licensor organization (e.g., 104 in FIG. 1) may analyze licenses granted to a given licensee organization, and identify one or more properties that the licensee does not currently license. Assuming that the licensor identifies one or more such unlicensed properties, the licensor may send representations of these unlicensed properties to a suitable licensing management service (e.g., 118 in FIG. 1). In turn, the licensing management service may center these representations of unlicensed properties to the licensee, along with a request to offer these unlicensed properties on a trial basis.

In scenarios that include unlicensed properties offered on a trial basis, the UI 500 may include representations of such trial properties. FIG. 5 provides examples of such trial properties in block form at 518. The UI 500 may also include buttons or other devices responsive to user input to accept the offered property under the terms of a trial license. These buttons or devices may be provided as part of the tools 504, or as separate “try” buttons.

In an example scenario, when an admin is allocating licenses to a given end-user, the UI 500 may expose or surface appropriate trial licenses for other services to that end-user. For example, if the end-user is already licensed for an e-mail service, the UI 500 would not typically offer another e-mail service, but may instead offer some other type or category of service. If the trial property is deemed acceptable after a trial, the trial license may transition to a more permanent license.

To facilitate transfers from trial licenses to permanent licenses, the volume licensing system may associate unique identifiers with particular licensees (e.g., a given company), and may allocate licenses that reference these unique identifiers. More generally, this unique identifier scheme may allow licensees to change name or change domain, yet still be tracked by the unique identifier from the licensor's perspective. The licensees may also change contacts without impacting their licenses, because the licenses track based on the unique identifier. This capability also allows the volume licensing system to transition the licensee seamlessly from a trial license to a permanent license.

In some implementations, the volume licensing system may present trial licenses only to admins, who may determine whether to allocate these trial licenses to particular end-users. The end-users may or may not be aware that a given property is licensed permanently or on a trial basis. However, other implementations could indicate to the end-users which items are offered under trial license, or could give end users the choice of whether to receive the trial license. In addition, some implementations may support advertising or other messages targeting particular end-users within a given licensee organization.

As indicated in FIG. 5, the results of the configurations entered through the UI 500 may be stored in a suitable database (e.g., the licensing database 120). In addition, data pre-existing in the database may be used to populate at least part of the UI. For example, referring also to the database diagram in FIG. 4, the UI 500 may populate the representations of applications or services (e.g., 502) that are available for allocation to the end user based on the database records 406. In another example, the UI 500 may calculate the licenses remaining (e.g., 512, 514, and 516) by comparing the max/min records 408 to the total number of previously allocated licenses, as shown in the records 410.

Regarding outputs from the UI 500, the UI may also update the record 416 in the database, in response to configuration settings entered through the UI elements 510. The UI 500 may also update the records 410 for any properties allocated to a particular user, as may be indicated by the selection tools 504. In addition, the UI 500 may also update these records for any sub-components (e.g., 506) allocated to the end-user, as indicated by the selection tools 508.

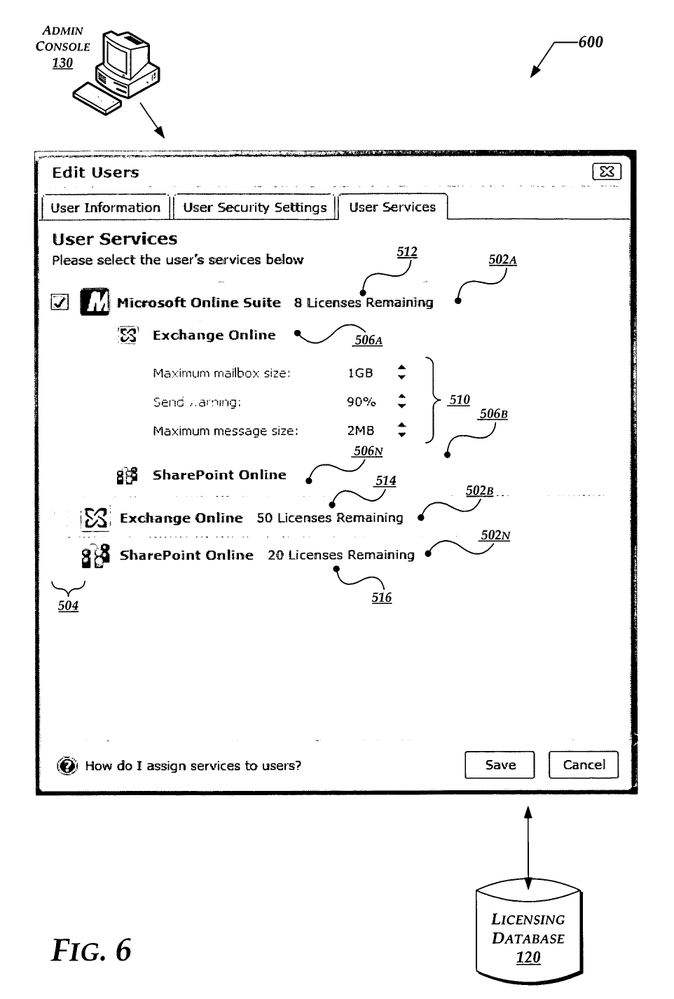

Having described the UI 500 for allocating licenses to new users in FIG. 5, the discussion now turns to a description of UI elements for modifying or changing allocations to existing users. This description is now presented with FIG. 6.

FIG. 6 illustrates UI elements, denoted generally at 600, for editing user configurations. For ease of reference, and not limitation, FIG. 6 may carry forward some reference numbers from previous drawings to refer to similar items. For example, FIG. 6 carries forward the admin console 130, the licensing database 120, as well as other items included in the description below.

Turning to the UI 600 more detail, the UI 600 may include representations of various properties available for allocation or deallocation to a given end-user. FIG. 6 carries forward examples of such properties at 502a, 502b, and 502n. In addition, FIG. 6 also carries forward examples of selection tools 504 (e.g., checkboxes or other suitable UI devices) corresponding respectively to these properties 502. An example shown, the property “Microsoft Online Suite” includes two subcomponents, carried forward at 506a and 506b. The UI 600 may also include tools, carried forward at 510, allowing admin personnel to adjust various parameters and configuration settings relating to a given license allocation to an end-user.

Admin personnel may use the UI 600 to modify various aspects of a license allocation to a particular end-user. For example, in response to admin input, the UI 600 may deallocate the property 502a if the admin deselects or deactivates the checkbox 504 corresponding to that property 502a. The UI 600 may allocate the properties 502b and/or 502n, in response to admin input that selects or activates the checkboxes 504 corresponding to these properties. Similarly, the UI 600 may alter configuration parameters in response to admin input directed to any of the configuration tools 510.

The licensing database 120 may provide initial or pre-existing values used to populate the UI 600. The UI 600 may also update the appropriate records in a licensing database 120, as the various parameters and values shown in FIG. 6 are changed. In addition, the UI 600 may update the numbers over many licenses available for various properties, in response to changes made by admins. FIG. 6 carries for examples of permitting allocation capacity at 512, 514, and 516.

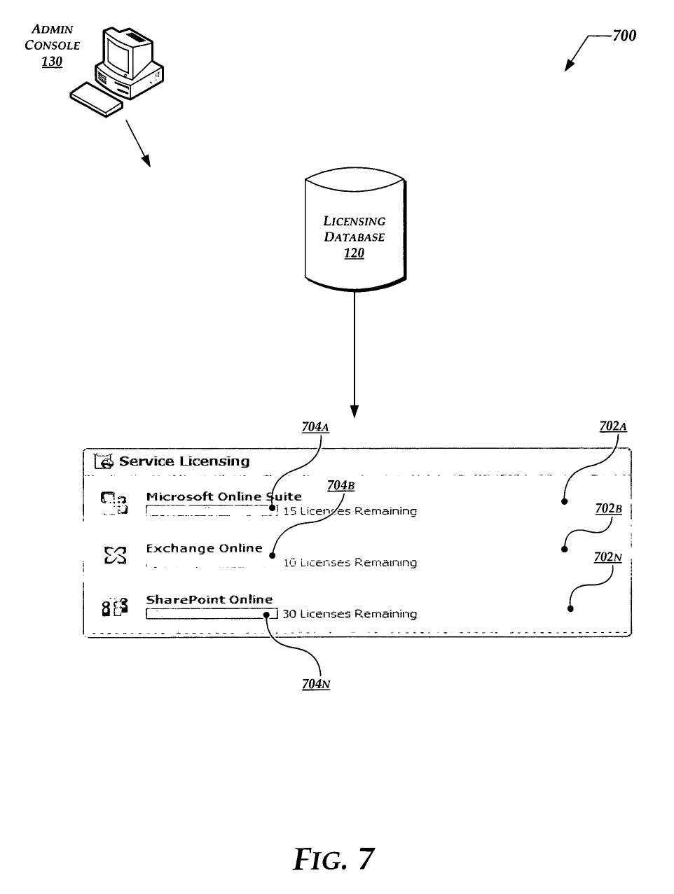

Having described the UI 604 editing existing user configurations, the discussion now proceeds to a description of UI is that indicate how many licenses are available and unallocated for different properties within a given licensee organization. This description is now provided with FIG. 7.

FIG. 7 illustrates UI elements, denoted generally at 700, for indicating how many licenses remain available for allocation across a given licensee organization. Put differently, the UI 700 may indicate, respectively for a variety of different properties, how many licenses remain unallocated within the licensee organization. In the example shown, the UI 700 provides availability statistics for three properties, denoted at 702a, 702b, and 702n.

Turning to the property labeled for example only as “Microsoft Online Suite”, the UI 700 indicates that fifty licenses remain available for allocation, as indicated by the bar graph device 704a. Likewise, for the property 702b, the UI 700 indicates that ten licenses remain available for allocation, as indicated by the device 704b. Finally, for the property 702n, the UI 700 indicates that thirty licenses remain available for allocation, as indicated by the device 704n.

It is noted that FIG. 7 provides the bar graph devices (collectively, 704) as an example of a UI tool that may indicate proportionally how many licenses have been allocated at a given time. However, this description contemplates that other devices are possible in different implementations, without departing from the scope and spirit of this description. For example, other implementations may include pie charts, or other types of graphical tools or devices.

The tools and techniques described herein may allow for multiple administrators at a given licensee organization, and may abide any of these administrators with an integrated view of all licenses and allocated licensees across that given licensee organization. Taking advantage of this visibility, different administrators may see what licenses the organization has already obtained before attempting to obtain more. In some cases, for example, one administrator might be able to allocate seats under licenses that were previously obtained by another administrator, but not yet allocated by that other administrator.

Within a given licensee organization, the volume licensing system may aggregate not only across licenses, but also across the users within the organization. Thus, a given administrator within the licensee organization may view not only the licenses, but also the users within the organization. Thus, the tool described herein may allocate licenses from a pool of unallocated licenses associated with the licensee organization.

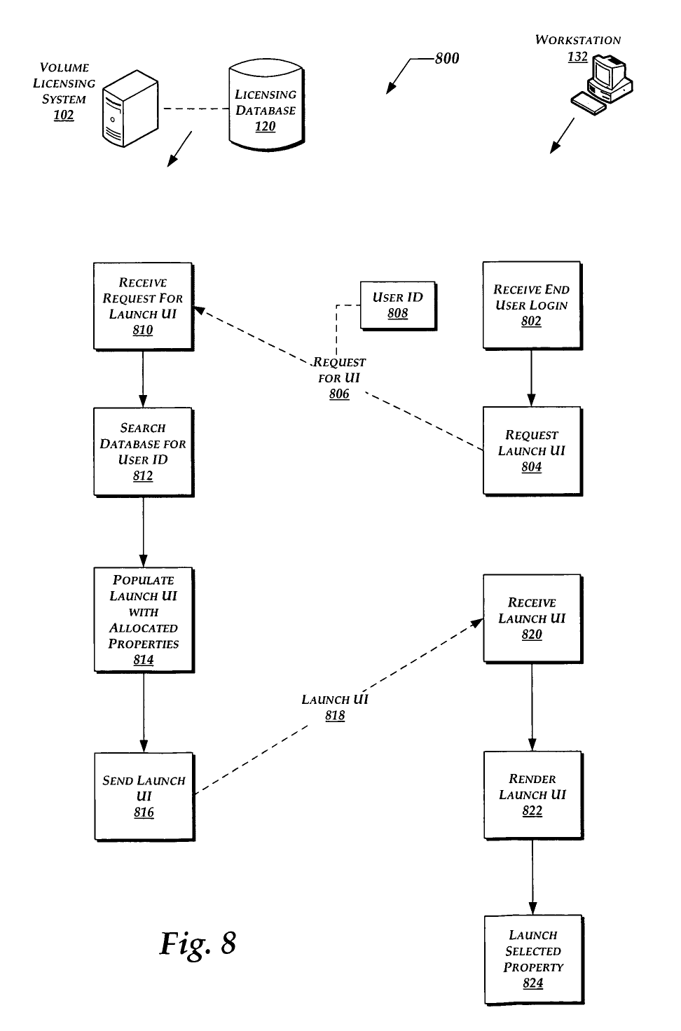

Having described the various UIs shown in FIGS. 5-7 related to administering or configuring licenses allocated to particular end-users and/or workstations, the discussion now turns to a description of processing flows involved in populating an example launch portal or launch UI presented on a workstation to an end-user. This description is now presented with FIG. 8.

FIG. 8 illustrates process flows, denoted generally at 800, for requesting in populating a launch portal or launch UI presented to an end-user on a workstation. For ease of reference, and not limitation, FIG. 8 may carry forward some reference numbers from previous drawings to refer to similar items. For example, FIG. 8 carries forward the volume licensing system 102 and licensing database 120, as well as the workstation 132.

Turning to the processes 800 in more detail, block 802 generally represents receiving an end-user login. In the interest of conciseness, this description assumes that the end-user possesses proper login credentials.

Block 804 generally represents the workstation requesting a launch UI in behalf of the end-user who logged in. FIG. 8 denotes this request for the launch UI at 806, and this request may include at least a user ID 808 associated with the end-user.

On the system end, block 810 represents receiving the request for the launch UI. In turn, block 812 represents searching appropriate database (e.g., the licensing database 120) using the user ID 808. If block 812 does not locate any records for the user ID 808, then block 812 may report an appropriate error, or return an empty launch portal to the user.

Assuming that the licensing database 120 contains records for the input user ID 808, block 814 represents populating the launch UI to include representations of properties allocated to the end-user. Recalling the previous discussion, the UIs shown in FIGS. 5-7 may be used to allocate properties to different end-users, with the licensing database 120 updated accordingly. In these examples, the licensing database 120 would include entries indicating all properties for which the different end-users have been allocated licenses. Thus, block 814 is able to populate the launch UI to include only those properties for which the given end-user has a license. If the given end-user does not have a license for a particular property, then block 814 would not include a representation of that property in the launch UI.

Block 816 generally represents sending the launch UI to the requesting workstation. More specifically, block 816 may include sending appropriate script or code (e.g., HTML) to the requesting workstation, so that when the requesting workstation renders the script or code, it presents the launch UI to the end-user. FIG. 8 generally represents the launch UI at 818, which includes any such script or code for rendering the launch UI.

Returning to the requesting workstation (e.g., 132), block 820 generally represents receiving the launch UI, and block 822 generally represents rendering the launch UI on the workstation. Once the launch UI is rendered on the workstation, the end-user may interact with it to execute one or more of the properties included in the UI. Generally, block 824 represents receiving user input selecting one or more of these properties, and launching or executing the selected property in response.

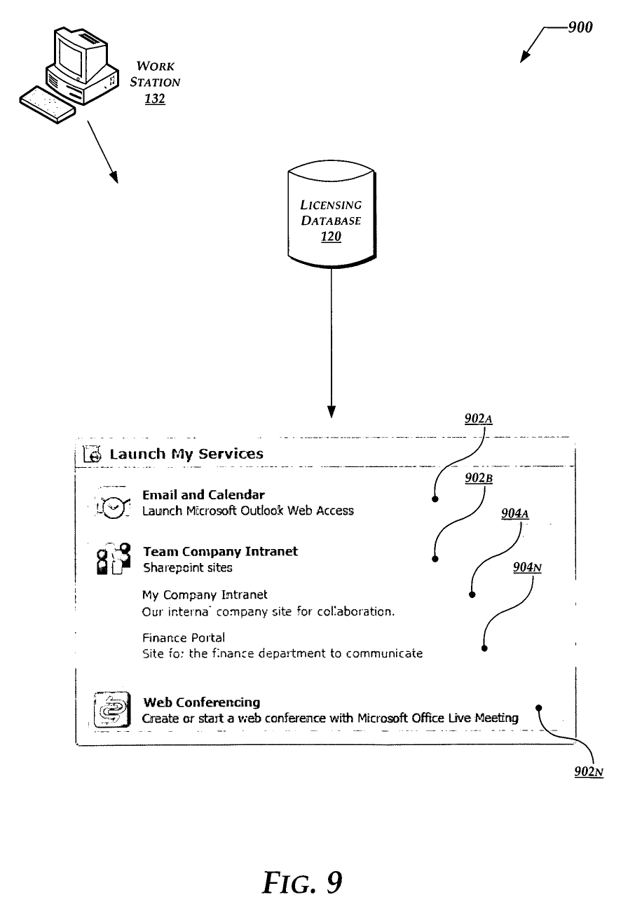

Having described the process flows 800 for requesting in populating a launch UI, the discussion now turns to a description of an example launch UI. This description is now presented with FIG. 9.

FIG. 9 illustrates UI elements, denoted generally at 900, that a workstation may present to enable the end-user to launch or access one or more properties licensed to the end-user. For ease of reference, but not limitation, FIG. 9 may carry forward some reference numbers from previous drawings to refer to similar items. For example, FIG. 9 carries forward the licensing database 120, as well as the workstation 132.

Turning to the launch UI 900 in more detail, the licensing database 120 may populate the UI based on previous license allocations stored in the database. When a given end-user logs into the workstation 132, processes running on the workstation and/or the volume licensing system (e.g., those shown in FIG. 8) may retrieve any properties for which the end-user has licenses, and may populate the launch UI to include representations of these different licensed properties.

FIG. 9 provides an example in which the given end-user is licensed to access three main properties, representations of which are denoted at 902a, 902b, and 902n. For example, the property 902a may pertain to e-mail and calendaring, the property 902b may be a corporate intranet, and the property 902n may be a conferencing application.

Turning to the property 902b in more detail, this property may include subcomponents relating to different aspects of the corporate intranet. In the example shown, a subcomponent 904a may correspond to an internal collaboration site, and a subcomponent 904n may correspond to a portal specialized for a particular department within the corporate enterprise. Recalling briefly the discussion of FIG. 4 above, the records for over four may correspond to particular departments or organizations within an overall enterprise. Thus, the launch UI 900 may populate the representations of the property 902b and the subcomponents 904a and 904n based on such records in the database 120.

As described above in connection with FIG. 8, the configuration and allocation processing that builds and populates the licensing database 120 may provide that the launch UI for a particular end-user contains only those properties for which the end-user has a license. If the end user does not have a license for a given property, the launch UI 900 would not contain a representation of that property.

In this manner, the volume licensing system 102 and the related subcomponents and processes described herein, may provide an integrated, centralized system for managing licenses across a given enterprise. This centralized system may thus enforce compliance with end-user licenses, by presenting end-users only with properties for which they have licenses.

Although the subject matter presented herein has been described in language specific to computer structural features, methodological acts, and computer readable media, it is to be understood that the invention defined in the appended claims is not necessarily limited to the specific features, acts, or media described herein. Rather, the specific features, acts and mediums are disclosed as example forms of implementing the claims.

To facilitate the present description, some of the foregoing drawing figures may include unidirectional arrows representing certain process and/or data flows. However, these arrows are chosen only for convenience of illustration and description, and do not limit possible implementations of this description. More specifically, any unidirectional arrows shown herein do not exclude or disclaim bidirectional data or process flows.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. At least one computer-readable storage medium containing instructions that, when loaded into at least one processor and executed, cause the processor to perform a method comprising:
sending information for presenting at least one licensing portal for display on at least one console associated with at least one recipient organization, wherein the licensing portal includes:
a representation of at least one property for which the organization has obtained a plurality of licenses;
an indication of how many licenses for the property remain available for allocation within the organization;
receiving at least one licensing request from the organization, wherein the licensing request relates to the property; and
validating the licensing request.

2. The computer-readable storage medium of claim 1, wherein the instructions for receiving at least one licensing request include instructions for receiving a licensing request to obtain at least one additional license for the property.

3. The computer-readable storage medium of claim 2, further comprising instructions for allocating at least one previously-unallocated license for the property in response to the licensing request.

4. The computer-readable storage medium of claim 3, further comprising instructions for updating the representation of the property in the licensing portal in response to the allocating.

5. The computer-readable storage medium of claim 1, wherein the instructions for receiving at least one licensing request include instructions for receiving a licensing request to allocate at least one of the licenses to at least one end-user.

6. The computer-readable storage medium of claim 5, wherein the instructions for validating the licensing request include instructions for determining whether executing the request to allocate the license would result in an overage.

7. The computer-readable storage medium of claim 1, wherein the instructions for receiving at least one licensing request include instructions for receiving a licensing request to deallocate at least one license previously allocated to at least one end-user.

8. The computer-readable storage medium of claim 7, wherein the instructions for validating the licensing request include instructions for determining whether executing the request to deallocate the license would result in an underage.

9. The computer-readable storage medium of claim 1, further comprising instructions for updating the indication of how many licenses for the property or made available, in response to allocations or de-allocations of the licenses.

10. The computer-readable storage medium of claim 1, further comprising instructions for communicating an error notification to the organization, if the licensing request is determined to be invalid.

11. The computer-readable storage medium of claim 1, further comprising instructions for executing the licensing request, if the licensing request is determined to be valid.

12. At least one computer-readable storage medium containing instructions that, when loaded into at least one processor and executed, cause the processor to perform a method comprising:
requesting, from a licensing system, information for presenting at least one licensing portal;
receiving the information for presenting the licensing portal, wherein the licensing portal includes:
a representation of at least one property for which a licensee organization has obtained a plurality of licenses;
an indication of how many licenses for the property remain available for allocation within the organization;
sending at least one licensing request to the licensing system, wherein the licensing request relates to the property; and
receiving a response to the licensing request.

13. The computer-readable storage medium of claim 12, wherein the instructions for sending at least one licensing request include instructions for sending a request to allocate at least one of the plurality of licenses.

14. The computer-readable storage medium of claim 12, wherein the instructions for sending at least one licensing request include instructions for sending a request to deallocate at least one previously allocated license.

15. The computer-readable storage medium of claim 12, further comprising instructions for updating the indication of how many licenses for the property remain available, in response to allocations or de-allocations of the licenses.

16. The computer-readable storage medium of claim 12, wherein the instructions for sending at least one licensing request include instructions for sending a request to modify at least one configuration parameter associated with at least one of the licenses as allocated to a least one end-user.

17. At least one computer-readable storage medium containing instructions that, when loaded into at least one processor and executed, cause the processor to perform a method comprising:
receiving at least one request for information to present a launch portal, wherein the request includes at least one user identifier corresponding to an end-user in a licensee organization;
populating the launch portal with representations of any properties for which the end-user has been allocated a license by the licensee organization; and
sending the information for presenting the launch portal.

18. The computer-readable storage medium of claim 17, further comprising instructions for searching at least one database using the user identifier, and further comprising instructions for locating at least one property for which the end-user has been allocated a license.

19. The computer-readable storage medium of claim 18, wherein the instructions for populating the launch portal include instructions for populating the launch portal to include a representation of at least the one located property.

20. The computer-readable storage medium of claim 17, further comprising instructions for populating the launch portal with representations of only those properties for which the end-user has been allocated a license.
